(19) United States
(12) Patent Application Publication
(10) Pub. No.: US 2005/0086454 A1
(43) Pub. Date: Apr. 21, 2005

(54) System and methods for providing a debug function built-in type microcomputer

(75) Inventors: Toshihiko Morigaki, Nagano-ken (JP); Makoto Kudo, Nagano-ken (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/377,762

(22) Filed: Mar. 4, 2003

(30) Foreign Application Priority Data
Mar. 8, 2002 (JP) 2002-063021

(51) Int. Cl. G06F 9/00

(52) U.S. Cl. 712/227

(57) ABSTRACT

The present invention provides a debug function built-in type microcomputer that is capable of restricting outputs only to necessary information to prevent necessary information from being terminated halfway and performing a more accurate tracing in real time, when an output signal line having a bit width fewer than a bit width of an inner bus is used for tracing information on the inner bus. The debug function built-in type microcomputer can be provided with registers that temporarily store bus information prepared for each target bus to be traced, a register writing condition judgment circuit that controls temporary storage of the bus information in the registers according to a trace condition stored in a setting register, and a multiplexer that selects and outputs the bus information temporarily stored in the registers.

### BACKGROUND OF THE INVENTION

1. Field of Invention

The present invention relates to a debug function built-in type microcomputer; More particularly, the invention relates to a debug function built-in type microcomputer with an improved bus tracing method.

2. Description of Related Art

For purposes of finding errors in a program and supporting correction tasks, a debug function can be provided to trace the program, stop the execution of the program when a designated line is reached or an address or data previously set is accessed and notify the same externally, and refer to and change the status of the memory and contents of variables in such an instance. Conventionally, there is a debug apparatus (debug tool) having the function described above, which is called an in-circuit emulator. A block diagram of a debug system using the in-circuit emulator is shown in FIG. 6. The debug system in FIG. 6 is composed of a user target system 50 and a debug tool 55 for debugging the same. Further, the user target system 50 can be composed of a microcomputer 51, a memory 52 and an input/output control circuit 53. The debug tool 55 can be composed of a microcomputer for debugging 56 and a monitor program memory 57.

In this system, the microcomputer 51 may be removed from the user target system 50 or its operation may be invalidated at the time of debugging. A probe of the debug tool 55 can be connected to that section, and the microcomputer for debugging 56 on the debug tool 55 is operated in place of the microcomputer 51 on the user target system 50. A monitor program stored in the monitor program memory 57 on the debug tool 55 is executed to control execution of the user program. By this, the microcomputer for debugging 56 can execute a target program to be debugged that is stored in the memory 52 on the user target system 50, and the microcomputer for debugging 56 can output trace information that cannot be obtained from the microcomputer 51 on the user target system 50. Also, in addition to information concerning a processor bus 54, internal information of the microcomputer 51 can also be traced.

However, this method encounters several problems. For example, the entire pins of the microcomputer 51 on the user target system 50 need to be connected to the debug tool 55, and thus the number of signal lines increases and the probing operation becomes expensive, and the probing operation becomes unstable. In particular, this method causes many problems in a microcomputer with a high operation frequency.

FIG. 7 shows a debug system using another conventional debug tool. In this example, a user target system 60 has a microcomputer 61 in which a serial interface 64 required for communication with a debug tool 68, and a sequencer 65 that interprets and executes signals sent from the debug tool 68 are internally built. The sequencer 65 may, according to a signal sent from the debug tool 68, temporarily stop the execution of a user program, make an access to a register 67, and use a bus controller 66 to access a memory 62 and/or an input/output control circuit 63 to thereby control the user program. Since signals from the serial interface 64 cannot be directly connected to a host computer 69 in many cases, the debug tool 68 may convert commands from the host computer 69 to signals that can be understood by the microcomputer 61, and convert signals from the microcomputer 61 to data format that can be understood by the host computer 69.

In this case, since the microcomputer 61 on the user target system 60 has the built-in sequencer 65, and the sequencer 65 makes accesses to the microcomputer 61 or the serial interface 64, its logic circuit for connecting to the debug tool 68 becomes complex, as well as its area on chip becomes large. Furthermore, there can be a problem in that, at the time of occurrence of addition of a register, such an occurrence cannot be coped with unless the sequencer 65 is modified.

FIG. 8 shows an exemplary block diagram of a structure of a debug system in which the present invention is applied. The debug system can be composed of a user target system 70 and a debug tool 80. The user target system 70 is composed of a microcomputer 71, a memory 72 and an input/output control circuit 73. The microcomputer 71 is composed of a processor core 74 and a debug unit 75. The processor core 74 accesses the memory 72 and/or the input/output control circuit 73 through processor buses 76 and 78 and executes programs. The processor core 74 is connected to the debug unit 75 through an internal debug interface 77 and the internal processor bus 78, and the debug unit 75 is connected to the debug tool 80 through an external debug interface 79. The debug unit 75 functions to convert output formats of signals and take output timings between the processor core 74 and the debug tool 80.

The debug system has a normal mode in which a user program is executed, and a debug mode in which a monitor program is executed. When the processor core generates a debug exception, the debug mode is set. Debug exceptions occur under the following conditions:

1) Single Step

A debug exception is generated at each execution of each command of the user program.

2) Command Break

A debug exception is generated immediately before an execution of an address that is set. An address can be set among three locations.

3) Data Break

When a read/write is executed for an address that is set, a debug exception is generated one or several commands after an execution of the reading/writing. An address can be set only at one location.

4) Software Break

A debug exception is generated by an execution of a brk command. A saving address at the time of occurrence of a debug exception is an address next to the brk command.

When the debug mode is set, the processor core executes a debug processing routine through the debug unit. By the debug processing routine, the user target program can be stopped at any desired address or executed in single steps. Furthermore, the debug processing routine realizes execution control functions such as reading and writing in a memory or a register, designation of an end address of the user program, designation of an execution start address of the user program. Also, when the processor core executes a return command on the debug processing routine to return to the normal mode, the processing returns to the normal mode, jumps over addresses designated by the return command, and re-starts executing the user program.

In the meantime, in the normal mode, the debug system executes the user program. In this instance, concurrently, it can selectively trace command information, command address information, data information and data address information.

By employing the system described above, the debug unit 75 having a debug function is included in the microcomputer 71 on the user target system 70. As a result, in realizing the debug function, the number of output signal lines (bit width) that connect the user target system 70 and the debug tool 80 can be reduced. Also, in the normal mode, while the microcomputer 71 is operated on the user target system 70, signals can be traced and debugged. As a result, responses at a high frequency are possible and accesses to the memory and/or the input/output apparatus can be readily made such that commands and data during operation can be accurately investigated. Also, the presence of the debug unit 75 is favorable because contents of the memory and the register in the debug tool 80 are not wrongly destroyed by the user program, and contents of the register used by the user are not wrongly destroyed by the debug tool 80.

However, because the internal processing of the CPU of the processor core 74 is entirely executed in 32 bits, reducing the number of output signal lines (bit width) of the external debug interface 79 that connects the user target system 70 and the debug tool 80 causes a problem in that satisfactory real time responses in a bus tracing may become difficult to take place. For example, when the external debug interface 79 has an 8-bit parallel output signal line, it needs a quadruple tracing time or a quadruple transfer speed in tracing contents of a 32-bit width internal bus, which is not practical. Even if a quadruple time is spent, when the processor core 74 shifts to the next operation, bus information that is being outputted is terminated at this moment even when the entire bus information has not been completely outputted, and the tracing also shifts to the next content, which causes a problem in that the traced result cannot be read. This is contradictory to the demand to reduce the number of output signal lines (bit width) connecting the user target system 70 and the debug tool 80, and causes a problem in that an output of important information for debugging is restricted. A method to solve these problems may be that the entire bus information is temporality stored in an internal memory, and then is read out for a specified period of time. However, this causes problems in that the internal memory needs to have a large capacity, the price of elements becomes expensive, and the chip area becomes larger.

Also, when a user circuit is added aside from the a general-purpose circuit within a chip of a microcomputer, conventionally, exclusive signal pins are allocated and used to output signals directly from the user circuit to a unit outside the chip, and a debugging is conducted by using a special tool or a logic analyzer. However, there are problems in that the manufacturing of a special tool is time-consuming and pushes up the cost, and the use of a logic analyzer is time-consuming and it is difficult to accommodate programs being executed on the microcomputer. Furthermore, due to the fact that signal pins exclusively used for debugging the user circuit are required, the cost increases, and due to the restriction on the number of pins, a problem may possibly be created in that other signals cannot be outputted outside the chip.

### SUMMARY OF THE INVENTION

As described above, in the conventional debug function built-in type microcomputer, when signals are traced while the microcomputer is operated on the user target system, there can be a problem in that, because the number of output signal lines (bit width) that connect the user target system and the debug tool is limited, a reading operation takes a long time, and data output is terminated before the entire information has not been outputted such that the output of information needed for debugging is restricted. Also, a special tool or a logic analyzer is required for analysis in debugging the user circuit, which increases the cost and is time-consuming. Furthermore, there is another problem in that exclusive signal pins are required and therefore the output of other signals are restricted.

It is an object of the present invention to solve the problems described above with a relatively simple method, and to provide a debug function built-in type microcomputer that is capable of restrictively outputting only necessary information, preventing the necessary information from being terminated halfway and performing more accurate tracing in real time, when tracing contents of an internal bus with an output signal line having a bit width fewer than a bit width of the internal bus, and debugging a user circuit using the same tool that is used for debugging a general-purpose circuit, under the same environment and with the same software.

To achieve the objects described above, the present invention is directed to a debug function built-in type microcomputer that can include a debug unit having a bus trace function and a bus brake function built in a microcomputer. The debug unit can trace information on a bus with an output bit width fewer than a bit width of the bus. The debug function built-in type microcomputer can include a bus information storage device that is provided for each target bus to be traced by the debug unit and temporarily stores the bus information, a bus information storage control device that controls temporary storage of the bus information in the bus information storage device according to a trace condition, a trace condition designation device that designates a trace condition to the bus information storage control device by an external setting, and a storage information selection device that selects the bus information temporarily stored in the bus information storage means as an output of the debug unit.

This realizes a debug function built-in type microcomputer that is capable of restrictively outputting only necessary information and preventing the necessary information from being terminated halfway, and performing more accurate tracing in real time, when tracing contents of an internal bus with an output signal line having a bit width fewer than a bit width of the internal bus.

A debug function built-in type microcomputer including a debug unit having a bus trace function and a bus brake function built in a microcomputer and a user circuit can be provided according to a use purpose by the user other than a general-purpose circuit. The debug function built-in type microcomputer can include a bus information selection device that selects bus information on a target bus to be traced by the debug unit as an output of the debug unit. The bus information selection device also selects and outputs the bus information of the user circuit as an output of the debug unit.

This realizes a debug function built-in type microcomputer that is capable of debugging the user circuit using the same tool that is used for debugging a general-purpose circuit, under the same environment and with the same software.

### BRIEF DESCRIPTION OF THE DRAWINGS

The invention will be described with reference to the accompanying drawings wherein like numerals reference like elements, and wherein:

FIG. 1 shows a structural drawing of an exemplary debug system using a debug function built-in type microcomputer in accordance with an embodiment of the present invention;

FIG. 2 shows an exemplary timing chart of signals at the time of tracing in the present invention;

FIG. 3 shows an exemplary timing chart of signals at the time of tracing in the present invention;

FIG. 4 shows an exemplary timing chart of signals at the time of tracing in the present invention;

FIG. 5 shows an exemplary structural drawing of an exemplary debug system using a debug function built-in type microcomputer in accordance with another embodiment of the present invention;

FIG. 6 shows an exemplary block diagram of a conventional debug system;

FIG. 7 shows an exemplary block diagram of a conventional debug system; and

FIG. 8 shows an exemplary block diagram of a debug system that uses the present invention.

### DETAILED DESCRIPTION OF PREFERRED EMBODIMENTS

A debug function built-in type microcomputer in accordance with the present invention will be described in detail below with reference to the accompanying drawings.

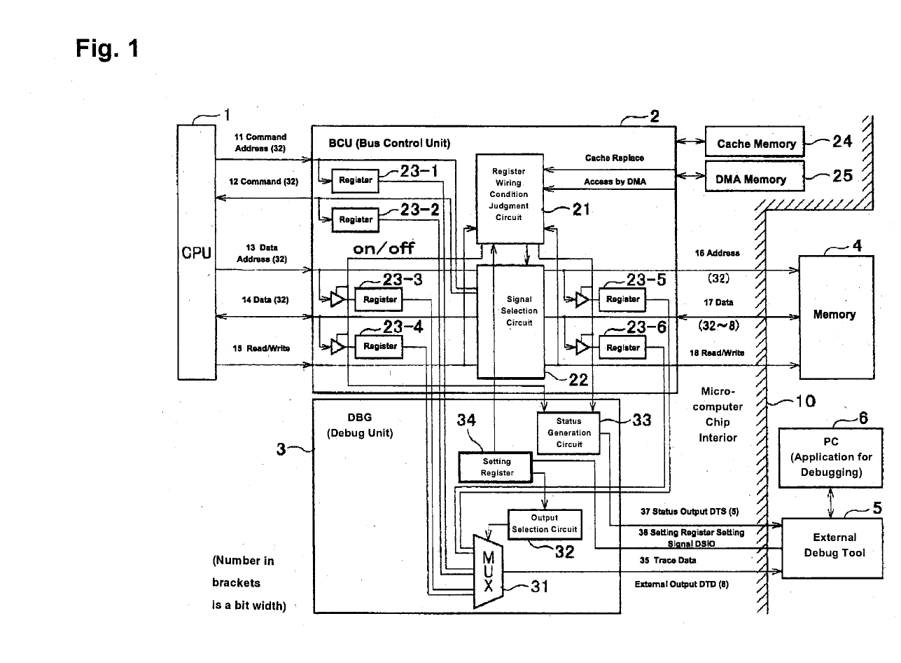

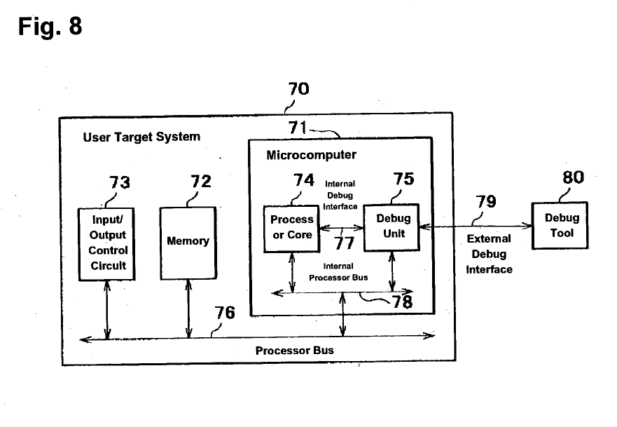

FIG. 1 shows a structural drawing of main parts of an exemplary debug system using a debug function built-in type microcomputer in accordance with an embodiment of the present invention. In FIG. 1, reference numeral 1 denotes a CPU, reference numeral 2 denotes a BCU (bus control unit), reference numeral 3 denotes a DBG (debug unit), reference numeral 4 denotes a memory, reference numeral 5 denotes an external debug tool, and reference numeral 6 denotes a personal computer for debugging. Also, reference numeral 24 denotes a cache memory, and reference numeral 25 denotes a DMA memory that is capable of DMA. The CPU 1, BCU 2, DBG 3, cache memory 24 and DMA memory 25 can be provided inside a microcomputer chip 10. The CPU 1 and BCU 2 in FIG. 1 together correspond to the processor core 74 in FIG. 8, the DBG 3 corresponds to the debug unit 75 in FIG. 8, the memory 4 corresponds to the memory 72 in FIG. 8, and the external debug tool 5 and personal computer for debugging 6 together correspond to the debug tool 80 in FIG. 8. Although the input/output control circuit 73 in FIG. 8 is omitted in here, it is placed in parallel with the memory 4.

A command address bus 11, a command bus 12, a data address bus 13 and a data bus 14 and a read/write signal line 15 are located between the CPU 1 and the BCU 2. Each of the buses 11-14 has a 32-bit width for data transfer. The BCU 2 and the memory 4 are connected through a 32-bit with address bus 16, an 8-32 bit width data bus 17, and a read/line signal line 18. As shown, the BCU 2 is connected to a destination that is represented by the memory 4. However, in addition to the memory 4, the data address bus 16 and the data bus 17 may also be connected to a peripheral unit and an external memory through an input/output interface not shown in the drawing, and are capable of sending addresses and data to them and receiving data from them. Furthermore, data can also be exchanged between the cache memory 24 and the DMA 25. Addresses and data are switched by a signal selection circuit 22 within the BCU 2 and exchanged between the CPU 1 and the memory 4.

Signals on the command address bus 11, command bus 12, data address bus 13, data bus 14, address bus 16 and data bus 17 are drawn in the DBG 3 through registers 23-1 through 23-6 within the BCU 2, selected by a multiplexer (MUX) 31 within the DBG 3 according to a designation of an output selection circuit 32, and transferred to the external debug tool 5 as an 8-bit width trace data external output (which corresponds to the external debug interface 79 in FIG. 8).

At this moment, the output selection circuit 32 receives inputs of an ACK (ACKnowledge) signal which the CPU 1 sends to a calling source to indicate a completion of operation when it accepts a request address and a valid signal indicating a timing to return data, and controls the multiplexer 31 according to these signals.

A register writing condition judgment circuit 21 allows writing only signals necessary for output in the registers 23-1 through 23-6, and does not take in unnecessary information. This can prevent necessary information that are present in the registers 23-1 through 23-6 from being overwritten by unnecessary information.

Trace conditions for signals to be traced or the like are sent in a setting register 34 by a setting register setting signal 36 that is inputted from, for example, the personal computer for debugging 6 through the external debug tool 5. If there are extra signal pins, trace conditions may be manually set at the setting register 34 by a switch, for example. Trace conditions set at the setting register 34 are sent to the output selection circuit 32 and the register writing condition judgment circuit 21 within the BCU 2.

Trace conditions that can be set at the setting register 34 are listed below, for example. The trace conditions may be set by designating on or off of specified 1 bit or 2 bits on the setting registers 34.

1) Read (read out) output enable (1-bit designation)

This is to set as to whether or not a read access signal (address or data at the time of reading) from the memory 4 is outputted.

2) Write (write in) output enable (1-bit designation)

This is to set as to whether or not a write access signal (address or data at the time of writing) to the memory 4 is outputted.

3) Address output byte number setting (2-bit designation)

This is to set as to how many lower bits of address data are to be outputted. One of 8-bit, 16-bit, 24-bit and 32-bit can be selected.

4) Data output enable (1-bit designation)

This is to set as to whether or not data is to be outputted.

5) Address output enable (1-bit designation)

This is to set as to whether or not an address is to be outputted.

6) Memory access output enable by the DMA memory 25 (1-bit designation)

This is to set as to whether or not an address or data when the DMA memory 25 accesses the memory 4 is to be outputted.

7) Memory access output enable at the time of refill/write-back in the cache memory 24 (1-bit designation)

This is to set as to whether or not an address or data is to be outputted when the memory 4 is accessed at the time of refill/write-back in the cache memory 24.

8) Memory access output enable by the CPU 1 (1-bit designation)

This is to set as to whether or not an address or data when the CPU 1 accesses the memory 4 is to be outputted.

These trace conditions are set at the setting register 34, and then sent to the register writing condition judgment circuit 21 and the output selection circuit 32.

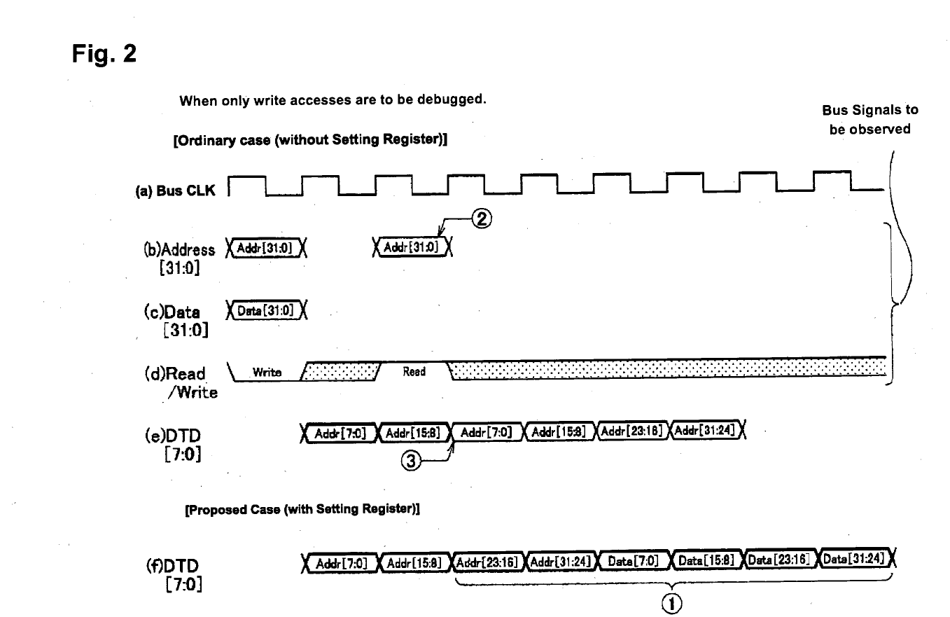

FIGS. 2-4 shows time charts of the signals in accordance with the present embodiment, each of which indicates the conventional art for comparison.

FIG. 2 shows an example when only write accesses are to be debugged. FIG. 2 shows signals as follows: (a) indicates a bus clock, (b) indicates an address on the address bus 16, (c) indicates 32-bit data on the data bus 17, (d) indicates a read/write signal 18, (e) indicates a conventional trace data external output without the setting register 34, and (f) indicates a trace data external output (DTD) 35 of the present embodiment.

Conventionally, because read information starting with an address ∉ that follows a write access starts being outputted at ∠, write access information corresponding to ε within the register 23 are overwritten by the read information, such that the output selection circuit 32 starts outputting the read address as a trace data external output, as indicated by (e).

In accordance with the present embodiment, the read information starting with the address ∉ is not taken in the register 23, and therefore the write access information ε within the register 23 are not overwritten. The output selection circuit 32 continues outputting the write access information ε from the trace data external output (DTD) 35, as indicated at (f).

By the method described above, information to be written in the register 23 are restricted to write accesses to be observed, which enables more necessary information to be externally outputted through the signal pins.

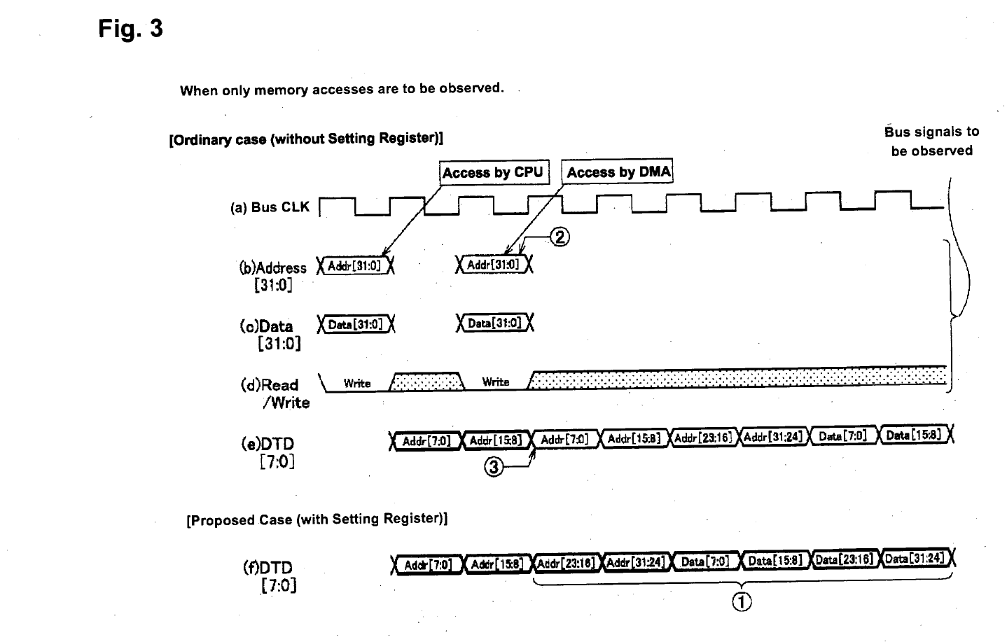

FIG. 3 shows an example when only memory accesses by the CPU 1 are to be observed. FIG. 3 shows signals as follows: (a) indicates a bus clock, (b) indicates an address on the address bus 16, (c) indicates 32-bit data on the data bus 17, (d) indicates a read/write signal 18, (e) indicates a conventional trace data external output without the setting register 34, and (f) indicates a trace data external output (DTD) 35 of the present embodiment.

When a memory access by the DMA memory 25 occurs following a memory access by the CPU 1, conventionally, because access information by the DMA memory starting with an address ∉ starts being outputted at ∠, write access information corresponding to ε within the register 23 are overwritten by the access information by the DMA memory 25, such that the output selection circuit 32 starts outputting the access information by the DMA memory 25 as a trace data external output, as indicated by (e).

In accordance with the present embodiment, the access information by the DMA memory 25 starting with the address ∉ is not taken in the register 23, and therefore the write access information ε within the register 23 are not overwritten. Therefore, the output selection circuit 32 continues outputting the write access information ε from the trace data external output (DTD) 35, as indicated at (f).

In this case also, by restricting information to be observed to memory accesses by the CPU 1, more necessary information can be externally outputted through the signal pins.

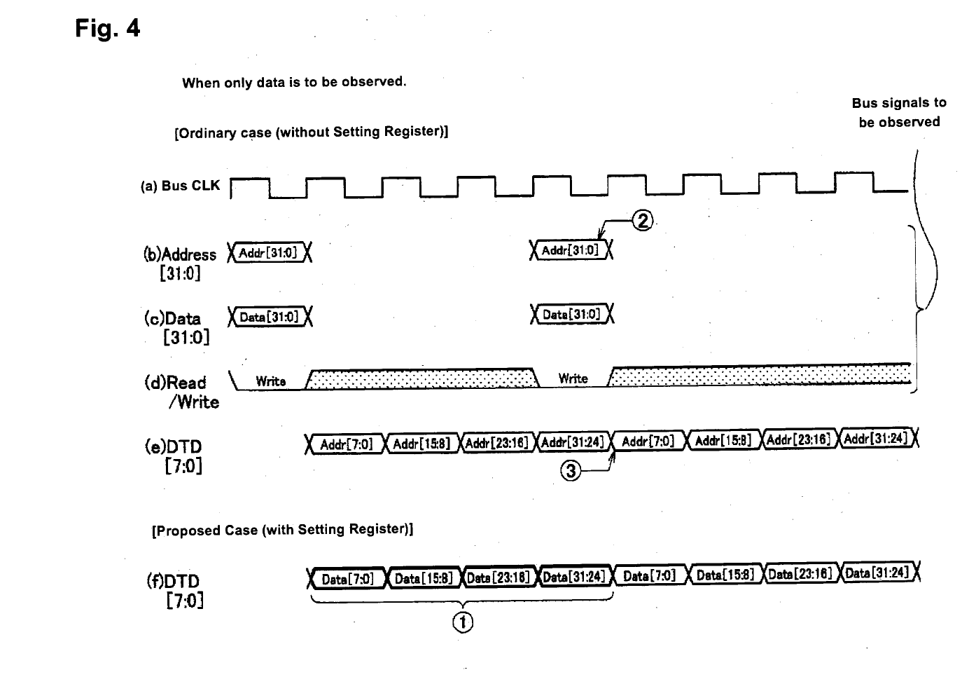

FIG. 4 shows an example when only data are to be observed. FIG. 4 shows signals as follows: (a) indicates a bus clock, (b) indicates an address on the address bus 16, (c) indicates 32-bit data on the data bus 17, (d) indicates a read/write signal 18, (e) indicates a conventional trace data external output without the setting register 34, and (f) indicates a trace data external output (DTD) 35 of the present embodiment.

When write accesses are being observed, conventionally, although data is supposed to be externally outputted following an address, an address ∉ shifts to the next write access, and an address of the new access information starts being outputted at ∠, such that write access data information corresponding to ε within the register 23 are overwritten by the new write access address information, such that the output selection circuit 32 continues outputting the write address as a trace data external output, as indicated by (e).

In accordance with the present embodiment, because the address information is not taken in, but only the data information is taken in the register 23, the write access data information ε within the register 23 are not overwritten by the address information. Therefore, the output selection circuit 32 continues updating and outputting the write access data information ε from the trace data external output (DTD) 35, as indicated at (f).

By the method described above, by restricting information to be observed to data, more necessary information can be externally outputted through the signal pins.

By setting trace conditions in the manner described above, unnecessary information can be prevented from being outputted at the time of debugging by the operations of the register writing condition judgment circuit 21 and the output selection circuit 32, which reduces incidences where necessary information is terminated halfway due to output of unnecessary information newly circulated on a bus.

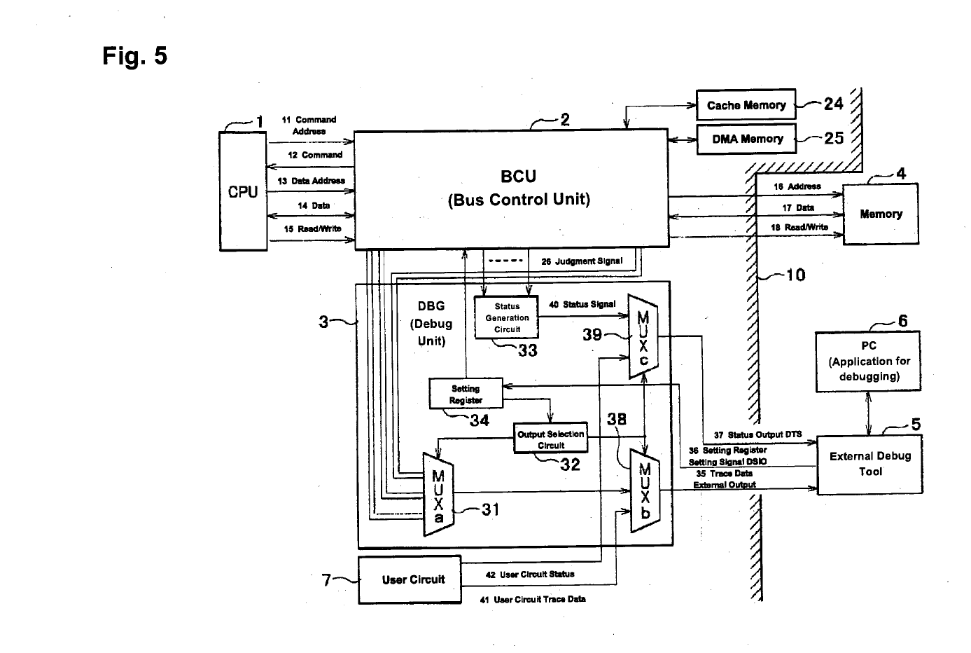

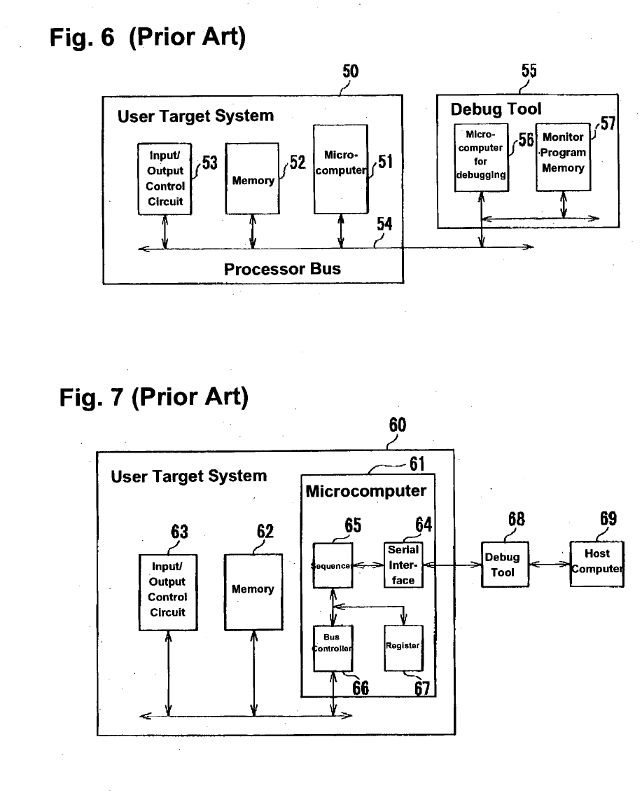

FIG. 5 shows an exemplary structural drawing of main parts of a debug system using a debug function built-in type microcomputer in accordance with another embodiment of the present invention. In FIG. 5, a CPU 1, a BCU 2, a memory 4, an external debug tool 5, and a personal computer for debugging 6 are generally the same as those indicated in FIG. 1. A cache memory 24, a DMA memory 25, a command address bus 11, a command bus 12, a data address bus 13, a data bus 14 and a read/write signal line 15 are also generally the same as those shown in FIG. 1.

In the present embodiment, a status generation circuit 33 can be provided within the DBG 3, and judgment signals 26 indicative of whether bus information to be traced from the BCU 2 is a command, address or data, whether an access to data is made by the CPU 1, the cache memory 24 or the DMA memory 25, what the size of accessed data is, whether it is reading or writing, and the like are sent to the status generation circuit 33. The status generation circuit 33 interprets these signals and generates a status signal 40.

Also, a user circuit 7 according to the customer's use purposes can be provided inside the microcomputer chip 10. The user circuit 7 inputs user circuit trace data 41 and user circuit status 42 in the DBG 3. The DBG 3 is provided with a multiplexer (MUXa) 31 that corresponds to the multiplexer (MUX) 31 in FIG. 1, as well as a multiplexer (MUXb) 38 and a multiplexer (MUXc) 39. The multiplexer (MUXb) 38 selects one of internal bus trace data outputted from the multiplexer (MUXa) 31 and the user circuit trace data 41, and outputs the same to the external debug tool 5. The multiplexer (MUXc) 39 selects one of the status signal 40 from the status generation circuit 33 and the user circuit status 42, and outputs the same to the external debug tool 5.

In this manner, the DBG 3 is provided with the multiplexer (MUXb) 38 and the multiplexer (MUXc) 39 that select the user circuit trace data 41 and the user circuit status 42 outputted from the user circuit 7 depending on settings. As a result, special pins for externally outputting and confirming the trace data 41 and the status 42 from the user circuit 7 are not required to be prepared, and thus an increase in the cost due to an increase in the number of pins can be avoided. Also, since output information from the user circuit 7 can be received by the general-purpose debug tool 5, preparation of special programs or special tools is not required to be made or prepared, and therefore the time and cost for manufacturing special tools can be eliminated, and the debugging efficiency can be improved.

Also, since the debug tool 5 can receive output information from the user circuit 7 simultaneously with other debug output signals, it is easy to accommodate programs being executed on the microcomputer 10 or signals inside the microcomputer 10 in terms of timing, which also improves the debug efficiency.

As described above, in accordance with the present invention, a debug function built-in type microcomputer can be provided with a bus information storage device that is provided for each target bus to be traced and temporarily stores bus information, a bus information storage control device that controls temporary storage of the bus information in the bus information storage device according to a trace condition, a trace condition designation device that designates a trace condition to the bus information storage control means by an external setting, and a storage information selection device that selects the bus information temporarily stored in the bus information storage means as an output of the debug unit.

This realizes a debug function built-in type microcomputer that reduces the probability of terminating necessary information halfway at the time of tracing to thereby perform more accurate tracing in real time through restricting to only necessary information and temporarily storing the same and outputting stored contents.

The present invention can decide trace conditions indicating as to whether the bus information pertains to a read access or a write access, as to whether the bus information is a data or an address, as to a connection destination of the bus information, and as to up to which bit of an address to be traced from a lower bit thereof is to be outputted, and specifies contents to be stored in the bus information storage device according to the trace conditions. By this, only necessary information can be selected, and incidents where tracing of important necessary information is prevented due to circulation of unnecessary information can be prevented.

The present invention can prohibit, according to the trace condition, information unnecessary for tracing from being temporarily stored in the bus information storage device. This can prevent incidents in which important necessary information are overwritten by unnecessary information and tracing of necessary information is prevented.

In accordance with the present invention, a debug function built-in type microcomputer is can include a bus information selection device that selects and outputs bus information on a target bus to be traced by a debug unit, wherein the bus information selection device also selects and outputs bus information of a user circuit. By this, bus information of the user circuit can be traced with the same tool, under the same environment, and with the same software, like bus information of a general-purpose circuit.

The present invention can include a status information output device that outputs status information, wherein the status information output device also selects and outputs status information of a user circuit. By this, status information of the user circuit can be debugged with the same tool, under the same environment, and with the same software, like status information of a general-purpose circuit.

The present invention is characterized in that the status information can include information for signal classification, output status, size and read/write. By this, contents of bus information do not need to be judged by the user at the time of debugging, and can be judged by a debug tool. This facilitates the analysis and improves the debug efficiency.

While this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. Various changes may be made without departing from the spirit and scope of the invention.

1. A debug function built-in type microcomputer including a debug unit having a bus trace function and a bus brake function built in a microcomputer, the debug unit tracing information on a bus with an output bit width that is fewer than a bit width of the bus, the debug function built-in type microcomputer, comprising:
a bus information storage device that is provided for each target bus to be traced by the debug unit and that temporarily stores bus information;
a bus information storage control device that controls temporary storage of the bus information in the bus information storage device according to a trace condition;
a trace condition designation device that designates a trace condition to the bus information storage control device by an external setting; and
a storage information selection device that selects the bus information temporarily stored in the bus information storage device as an output of the debug unit.

2. The debug function built-in type microcomputer according to claim 1, the trace condition that is a criterion of control by the bus information storage control device including information indicating whether the bus information pertains to a read access or a write access.

3. The debug function built-in type microcomputer according to claim 1, the trace condition that is a criterion of control by the bus information storage control device including information indicating whether the bus information is a data or an address.

4. The debug function built-in type microcomputer according to claim 1, the trace condition that is a criterion of control by the bus information storage control device including a connection destination of the bus information.

5. A debug function built-in type microcomputer according to claim 1, the trace condition that is a criterion of control by the bus information storage control device including a bit number indicating as to up to which bit of an address to be traced from a lower bit thereof is outputted.

6. The debug function built-in type microcomputer according to claim 1, the bus information storage control device prohibiting, according to the trace condition, information unnecessary for tracing from being temporarily stored in the bus information storage device.

7. A debug function built-in type microcomputer including a debug unit having a bus trace function and a bus brake function built in a microcomputer and a user circuit provided according to a use purpose by the user other than a general-purpose circuit, the debug function built-in type microcomputer, comprising:
a bus information selection device that selects bus information on a target bus to be traced by the debug unit as an output of the debug unit, and a user circuit bus selection input device that inputs bus information of the user circuit in the bus information selection device,
the bus information selection device also selecting and outputting the bus information of the user circuit inputted from the user circuit bus information input device as an output of the debug unit.

8. The debug function built-in type microcomputer according to claim 7, further comprising:
a status information output device that outputs bus information to be traced and status information indicating contents of the bus information traced as the output of the debug unit; and
a user circuit status information input device that inputs status information of the user circuit in the status information output device,
the status information output device also selecting and outputting the status information of the user circuit inputted from the user circuit status information input device as the output of the debug unit.

9. The debug function built-in type microcomputer according to claim 8, the status information including information for signal classification, output status, size and read/write.
